(19) United States
(12) Patent Application Publication
(10) Pub. No.: US 2017/0138350 A1
(43) Pub. Date: May 18, 2017

(54) Method and/or Apparatus for Converting Energy from Tree Branches

(71) Applicant: Armen Sevada Gharabegian, Glendale, CA (US)

(72) Inventor: Armen Sevada Gharabegian, Glendale, CA (US)

(21) Appl. No.: 15/333,884

(22) Filed: Oct. 25, 2016

Related U.S. Application Data
(60) Provisional application No. 62/246,123, filed on Oct. 25, 2015.

(51) Int. Cl. F03D 9/25; H02J 7/00; H02K 7/06; F03D 5/06; H02K 7/18

(52) U.S. Cl. CPC F03D 9/25; F03D 5/06; H02K 7/1853; H02K 7/06; H02J 7/0068

(57) ABSTRACT

A tree power generation system, comprises one or more tree branch clasps, the one or more tree branch clasps to attach to branches of a tree and one or more power generators. The one or more wires couple the one or more tree branch clasps to the one or more power generators, wherein movement in the branches of the tree causes movement in the one or more wires and the power generator generates electrical energy. The two or more tree branch clasps may be attached to one tree branch.

### RELATED APPLICATIONS

This application claims priority to U.S. provisional patent application Ser. No. 62/246,123, filed Oct. 25, 2015, entitled “Method and/or Apparatus for Converting Energy from Tree Branches,” the disclosure of which is hereby incorporated by reference.

### BACKGROUND

1. Field

The subject matter disclosed herein relates to a methods, apparatus and systems for generating power and/or energy from trees, and more specifically, generating power and/or energy from movement of tree branches.

2. Information/Background of the Invention

One form of electricity and/or power generation utilizes water power that turns electricity producing turbines to power electric power plants. Another form of electricity utilizes fossil fuels to power electric power plants. Fossil fuel electric power plants consume huge amounts of non-replenishable resources of oil and coal. Fossil fuel electric plants also are not environmentally friendly. In addition, electricity or power may be generated utilizing chemical reactions, nuclear reactions (fission and/or fusion), photo-voltaic reactions (solar cells) and mechanical interactions (wind, hydro-electric and geothermal).

Some energy sources are efficient while others are not. Many of these energy sources have negative environment impacts. A number of these energy sources are costly when compared to electricity and/or power generated utilizing fossil fuels. Wind energy is a particularly beneficial energy source technology that has a minimal environmental impact. However, wind turbines require a large investment, may need to be placed in a windy environment, and may cause problems with respect to birds' flights.

Accordingly, alternative embodiments may be desired to generate power from wind.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 illustrates a tree branch power system according to an embodiment;

FIG. 2 illustrates a power generator according to an embodiment;

FIG. 3 illustrates a processing device according to an embodiment; and

FIG. 4 illustrates a method of supplying power from tree branches according to an embodiment.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a problem, such as signal processing of signal samples, for example, may be allocated among computing devices, including one or more clients and/or one or more servers, via a computing and/or communications network, for example. A network may comprise two or more network devices and/or may couple network devices so that signal communications, such as in the form of signal packets and/or frames (e.g., comprising one or more signal samples), for example, may be exchanged, such as between a server and a client device and/or other types of devices, including between wireless devices coupled via a wireless network, for example.

A network may comprise two or more network devices and/or may couple network devices so that signal communications, such as in the form of signal packets, for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals (e.g., signal samples), such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. As mentioned, signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and/or similar terms are to be associated with appropriate physical quantities and are intended to merely be convenient labels.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context. In a context of this application, if signals, instructions, and/or commands are transmitted from one component (e.g., a controller or processor) to another component (or assembly), it is understood that signals, instructions, and/or commands may be transmitted directly to a component, or may pass through a number of other components on a way to a destination component. For example, a signal transmitted from a controller or processor to a motor may pass through glue logic, an amplifier, and/or an interface. Similarly, a signal transmitted through an cooling system may pass through an air conditioning module, and a signal transmitted from a sensor to a controller or processor may pass through a conditioning module, an analog-to-digital controller, and/or a comparison module.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

The Internet refers to a decentralized global network of interoperable networks that comply with the Internet Protocol (IP). It is noted that there are several versions of the Internet Protocol. Here, the term Internet Protocol, IP, and/or similar terms, is intended to refer to any version, now known and/or later developed of the Internet Protocol. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately compatible and/or compliant signal packets and/or frames. It is noted that there are several versions of the Hypertext Transfer Protocol. Here, the term Hypertext Transfer Protocol, HTTP, and/or similar terms is intended to refer to any version, now known and/or later developed. It is likewise noted that in various places in this document substitution of the term Internet with the term World Wide Web (Web′) may be made without a significant departure in meaning and may, therefore, not be inappropriate in that the statement would remain correct with such a substitution. Although claimed subject matter is not in particular limited in scope to the Internet and/or to the Web; nonetheless, the Internet and/or the Web may without limitation provide a useful example of an embodiment at least for purposes of illustration.

Also as used herein, one or more parameters may be descriptive of a collection of signal samples, such as one or more electronic documents, and exist in the form of physical signals and/or physical states, such as memory states. For example, one or more parameters, such as referring to an electronic document comprising an image, may include parameters, such as time of day at which an image was captured, latitude and longitude of an image capture device, such as a camera, for example, etc. In another example, one or more parameters relevant to content, such as content comprising a technical article, may include one or more authors, for example. Claimed subject matter is intended to embrace meaningful, descriptive parameters in any format, so long as the one or more parameters comprise physical signals and/or states, which may include, as parameter examples, name of the collection of signals and/or states (e.g., file identifier name), technique of creation of an electronic document, purpose of an electronic document, time and date of creation of an electronic document, logical path of an electronic document (or portion thereof), encoding formats and/or standards used for encoding an electronic document, and so forth.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In an embodiment, a controller typically performs a series of instructions resulting in data manipulation. In an embodiment, a microcontroller may be a compact microcomputer designed to govern the operation of embedded systems in motor vehicles, robots, office machines, complex medical devices, mobile radio transceivers, vending machines, home appliances, and various other devices. In an embodiment, a microcontroller may include a processor, a, and/or peripherals. In an embodiment, a controller may be a commercially available processor such as an Intel Pentium, Motorola PowerPC, SGI MIPS, Sun UltraSPARC, or Hewlett-Packard PA-RISC processor, but may be any type of application-specific and/or specifically designed processor or controller as many other processors and/or controllers are available. In an embodiment, a controller may be connected to other system elements, including one or more memory devices, by a bus. Usually, a processor or controller, may execute an operating system which may be, for example, a Windows-based operating system (e.g., Windows NT, Windows 2000 (Windows ME), Windows XP operating systems) available from the Microsoft Corporation, a MAC OS System X operating system available from Apple Computer, one of many Linux-based operating system distributions (e.g., the Enterprise Linux operating system available from Red Hat Inc.), a Solaris operating system available from Sun Microsystems, or a UNIX operating systems available from various sources. Many other operating systems may be used, and embodiments are not limited to any particular implementation.

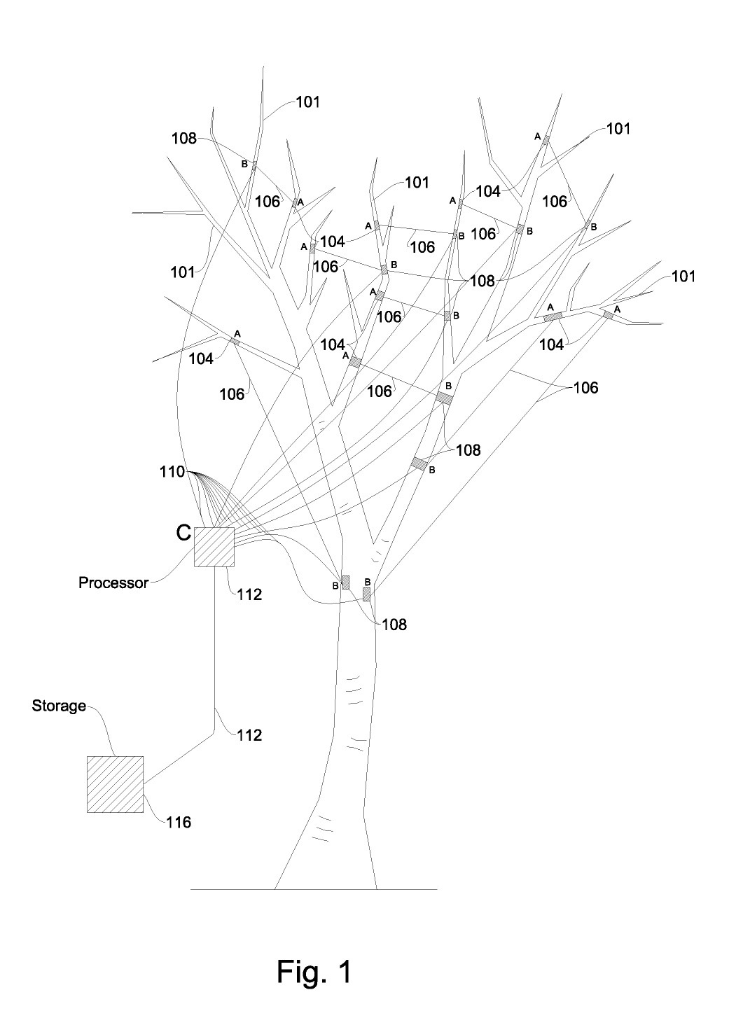

FIG. 1 illustrates a tree power generation system according to an embodiment. A tree power generation system 100 comprises a one or more tree branch clasps 104, one or more wires 106, one or more power generators 108, one or more cables 110, one or more processing devices 112 and/or a storage device 116. FIG. 1 illustrates a tree with one or more tree branches 101. As is shown in FIG. 1, a tree branch clasp 104 on one tree branch 101 is connected and/or coupled via wire 106 to a generation device 108 (or power generator 108) located on another tree branch. In order to measure wind generation and/or tree branch sway, a tree branch clasp 106 and generation device 108 may be located on different tree branches 101. In this manner, movement and/or sway can be measured. In an embodiment, one or more tree branch clasps 106 may be located on different portions and/or sections of a tree branch (e.g., at a lower portion or an upper portion of a tree branch). In embodiments, one or more tree branch clasps 104 located on different portions of a tree branch may be connected and/or coupled via wires 106 to one or more generation devices 108 located on a different tree branch 101. Alternatively, one or more tree branch clasps 104 located on different portions of a tree branch 101 may be coupled and/or coupled via wires to generation apparatus/devices 108 (or power generators 108) located on different tree branches. For example, three tree branch clasps 104 on one tree branch may be coupled and/or connected to a generation device 108 on a first branch, a generation device 108 on a second branch, and a generation device 108 on a third branch.

Although only one tree is shown, a wind energy power generation system 100 may comprise multiple trees with each tree including one or more tree branch clasps 104, one or more wires 106, one or more generation devices 108, one or more cables 110, and one or more processing devices 112. In embodiments, a storage device 116 may be shared among one or more trees. In embodiments, one or more processing devices 112 may be shared among one or more trees. In an embodiment, a wind energy power generation system 100 may comprise multiple storage devices 116 and/or multiple processing devices 112.

In embodiments, a processing device 112 may be installed, positioned or located on a portion of a tree, such as a tree trunk. In embodiments, a processing device 112 may be located, positioned, and/or resident on a ground surface. In embodiments, a cable 110 (from generation device 108) may be placed, positioned, or run down a tree branch and/or tree trunk to a processing device 112. In this embodiment, a cable 110 may be taped, adhered, and/or fastened to a tree branch or a tree trunk. In embodiments, a storage device 116 may be located on a ground surface. In embodiments, a processing device 112 may be placed or located in a same physical enclosure as a storage device 116, or alternatively, a processing device 112 may be located in separate physical enclosure from a storage device 116. Locations of a processing device 112 and/or a storage device 116, and whether or not these devices are located in a same physical disclosure may be impacted by environmental conditions, space between trees, ground surface conditions, and other similar factors. In embodiments, a processing device 112 and/or a storage device 116 may also comprise a cooling apparatus, such as a fan and/or a vent. In an embodiment, a cooling apparatus may allow dissipation of heat generated by the components, processors, controllers, and/or devices in the processing device 112 and/or the storage device 116.

In embodiments, a tree branch clasp 104 may be placed on a tree branch 101 in a tree. In embodiments, a tree branch clasp 104 may be placed around an entire circumference of a tree branch. In embodiments, a tree branch clasp may be positioned as to cover more than 50% of a tree branch. In embodiments, a tree branch clasp 104 may be positioned to surround a substantial portion of a tree branch (e.g., 60-95% of a circumference, diameter, and/or surface of a tree branch). In embodiments, a tree branch clasp 104 may make contact with surfaces of a tree branch. A tree branch clasp 104 may not rub bark or other surface materials from a tree branch. In embodiments, a tree branch clasp 104 may fit snugly and/or closely enough around a tree branch 101 as to move when wind blows and causes a tree branch 101 to sway or move in one of a variety of directions. Minimal slippage between a tree branch 101 and a tree branch clasp 104 is desired in order to capture as much movement as possible from a tree branch when wind is present in an embodiment.

In embodiments, for example, wind may cause a tree branch to sway in a up and down fashion and may cause a tree branch clasp 104 to rotate or move in a lateral, radial, and/or vertical direction. In embodiments, a tree branch clasp 104 may be comprised of a plastic and/or a fabric material. In an embodiment, a tree branch clasp 104 may be comprised of a rubber material. In embodiments, an inner surface of a tree branch clasp 104 may comprise a material that is a non-irritant to bard of tree branches so as to not disturb a surface of a tree branch. In embodiments, for example, an inner surface of a tree branch clasp 104 may be coated with a substance to increase a grip of a tree branch clasp 104 to a tree branch 101.

The specification may refer to a tree branch clasp as a device and/or assembly that is coupled, connected, and/or attached to a portion and/or section of a tree branch that couples and/or connects a body to a tree branch in order to detect movement in any direction, e.g., radial, vertical, and/or horizontal, of a tree branch. In an embodiment, movement may be caused by wind moving through branches of a tree. The tree branch clasp may also be referred to as a branch or tree branch harness, a branch or tree branch collar, a branch or tree branch movement sensor and/or detector, a tree branch saddle, and/or a tree branch bracelet, and other similar names, all of which may be utilized interchangeably in this application. In embodiments, a tree branch clasp and/or the tree branch power generation system described herein may include many novel and non-obvious features. Other power generation systems operating in trees have tried to obtain power from movement of a tree trunk and or movement of a weight attached to a tree trunk. One novel and new feature is utilization of branches of the present application within a same tree and attempting to capture movement in a plurality of tree branches in order to capture as much energy from a tree as possible, rather than focusing on one tree trunk or a movement measured between multiple trees (both of which leave large amounts of wind energy not captured and/or utilized). For example, U.S. Pat. No. 6,825,574 describes a cable tether having one end attached to a tree trunk adjacent its upper area and the other end attached of the tether line is secured to a front end of a ratcheting arm. When the wind force bends the tree from its static upright position, the ratcheting arm is pulled downwardly causing a winding drive spur gear to rotate causing the spring motors to be wound incrementally each time the wind blows the tree from its static upright position. In U.S. Pat. No. 6,825,573, an electricity generator is mounted on the frame assembly and there is rotation transmission structure connected to a power generation drive shaft of an electricity generator. U.S. Pat. No. 7,936,079 utilizes movement between two trees to generate power. Illustratively, in U.S. Pat. No. 7,936,079, a distributed system of electrical generators utilizing wind driven natural motion of trees comprises pull-retract generators deriving torque from the back and forth swaying of neighboring trees and cables, wherein one set of cables acting as support and the other acting as a spring-tensioned flexible rack that drives the pinion gear of the pull-retract generator and also supports the pull-retract generator between the trees. The cables are attached to the pull-retract generators and provide the tension required to support and retract the pull-retract generator mechanism. Tree saddles attach the pull-retract generator cabling to the trees.

In embodiments as illustrated in FIG. 1, a tree branch clasp 104 may be positioned and/or installed on portions of a tree branch that are closer to a tree trunk and therefore larger in circumference and/or diameter as compared to tree branches that are distal from a tree trunk. In an embodiment, a tree branch clasp 104 may be smaller for portions of a tree branch that are farther away from a tree trunk and thus, smaller in circumference and/or diameter. In an embodiment, tree branch clasps 104 may be manufactured with different diameters or circumferences so as to be able to firmly adhere, attach or grip on a tree branch.

In embodiments, a wire 106 may be attached to a tree branch clasp 104. In embodiments, a wire 106 may be adhered to an outer surface of a tree branch clasp 104. In an embodiment, a wire 106 may move and/or sway when a tree branch sways due to wind and/or movement of other tree branches. Accordingly, a wire may be a conductive and/or insulated wire in that a wire 106 in a tree branch power generation system 100 is capturing mechanical movement of a device (e.g., tree branch clasp) and electrical properties of a wire 106 may not be as big of a factor as mechanical properties of a wire 106. In an embodiment, an end of a wire 106 may be looped through an eyelet on a tree branch clasp 106 and tied off to connect and/or be attached to a tree branch clasp. In embodiments, an end of a wire 106 may be looped through an eyelet and adhered to a surface of a tree branch clasp 104 to connect and/or attach to a tree branch clasp. In embodiments, a wire 106 may be welded to an outer surface of a tree branch clasp 104. In embodiments, a wire 106 may be fastened or connected in a variety of other similar manners to a tree branch clasp 104. In embodiments, a connection and/or attachment may need to be secure and/or tight in order for a wire 106 to capture and/or transfer mechanical movement to a generation apparatus/device 108. In embodiments, a wire 106 may be thin in diameter. In embodiments, a wire 106 may have a diameter of approximately 1/32^{nd} inch and/or a 40 gauge wire. In an embodiment, a wire 106 may have a diameter of approximately 1/0^{th} inch to 1/64^{th} inch. In embodiments, a wire 106 may have a clear color, a camouflage color, and/or another color matching a tree branch to blend in with a tree. In embodiments, a wire color choice may allow animals and insects to identify a structure as a wire and not be injured by a wire by, for example, flying into a wire 106 in a tree. In embodiments, a wire 106 should not have a lot of slack when connected and/or attached between a tree branch clasp 104 and a generator device 108.

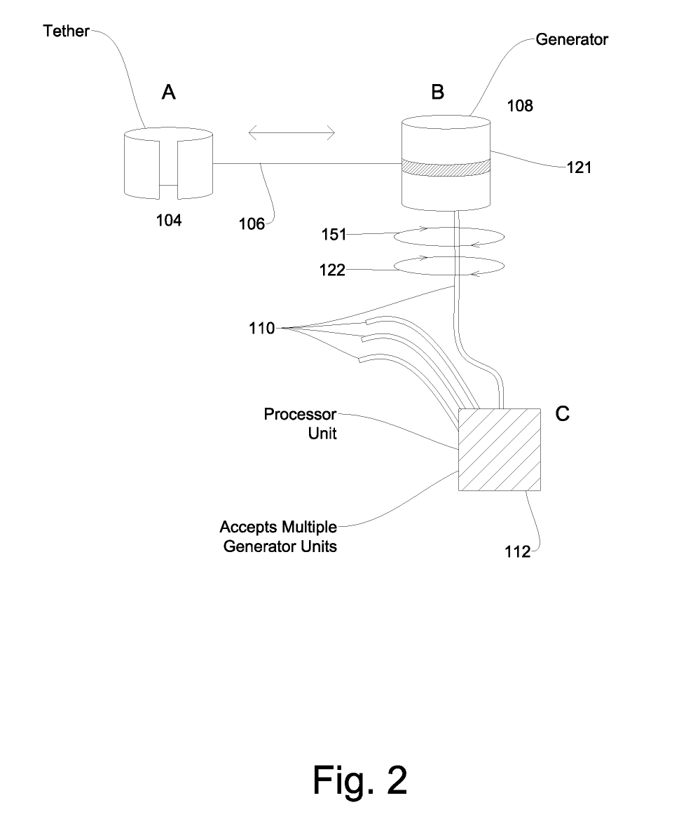

In embodiments, another end of a wire 106 may be connected to a generation apparatus 108 or generating device. FIG. 2 illustrates a power generator/generation apparatus according to an embodiment. A generation apparatus may also be referred to as a generation device, a power generation apparatus, a power generation device, a generating device, a generating apparatus, and/or other similar names, all of which may be utilized interchangeably in this application. A generation apparatus 108 described herein may include novel and non-obvious features. In embodiments, a generation apparatus 108 may comprise a rotation assembly 121 and an electrical generator 122. In embodiments, a second or another end of a wire 106 may be connected to a rotation assembly 121 in a generation apparatus 108. As discussed previously, a wire 106 may be connected, attached, and/or adhered to a rotation assembly 121 via similar means as discussed above regarding attaching a wire 106 to a tree branch clasp 104. In an embodiment, a rotation assembly 121 may move and/or rotate in a circular direction or substantially circular direction, as illustrated by reference number 151. In an embodiment, a circular direction 151 may be a clockwise or a counterclockwise direction, or a substantially clockwise or counterclockwise circular direction identifying there may be wobble in a rotation apparatus 121. Movement and/or rotation of rotation assembly 121 may be caused and/or initiated by movement and/or displacement of wire 106, which in turn may be cause by movement and/or displacement of tree branch clasp 104. In embodiments, as discussed previously, swaying of tree branches may cause movement and/or displacement of the tree branch clasp 104.

In embodiments, a rotation assembly 121 may be coupled and/or connected to an electrical generator 122. Movement and/or rotation of a rotation assembly 121 may cause an electrical generator to generate a digital and/or analog signal representing current and/or voltage values. In embodiments, an amplitude or size of movement and/or rotation of a rotation assembly 121 may correspond to an amplitude or value of a digital and/or analog electrical signal created and/or generated by an electrical generator 122. In an embodiment, an electrical generator 122 may be an electric motor. In an embodiment, a rotation assembly 121 may be a hub and/or shaft assembly, where a wire 106 may be connected to a hub, and a hub may be connected, coupled, or adhered to a shaft assembly (e.g., a drive shaft). In this illustrative embodiment, movement of wire 106 may cause a hub to rotate, which in term may cause a shaft assembly to rotate. In embodiments, a shaft assembly may be coupled and/or connected to an electrical generator 122 and rotation of a shaft assembly may cause an electrical generator 122 (e.g., a motor 122) to generator an analog or digital electrical signal associated with current and/or voltage values. In embodiments, a shaft assembly may comprise gears which engage gears in an electrical generator 122 (e.g., motor) to cause a generator to create electricity. In an embodiment, an electrical generator 122 may comprise at least a shaft assembly and a motor, where an electrical generator's 122 shaft assembly may be connected to a rotation assembly 121. In an illustrative embodiment, a rotation assembly 121 may comprise a hub attached to a wire 106. In embodiments, a hub may comprise an opening in a middle portion of a hub. In this illustrative embodiment, an opening may comprise teeth that may engage teeth and/or indentations in a shaft assembly. Accordingly, when a hub assembly rotates (due to movement of a tree branches), teeth in an opening may cause and/or result in rotation in a shaft assembly of an electrical generator and this may cause a digital and/or analog electrical signals to be generated. In embodiments, a ball bearing may be located in an opening and a shaft assembly of an electrical generator may fit into a ball bearing. Again, when a hub assembly rotates, a ball bearing may cause a shaft assembly inserted into an opening of a hub assembly to rotate and thus cause a digital and/or analog electrical signal to be generated. In embodiments, a coil/recoil spring may be utilized as a rotation assembly 121, wherein movement in a wire 106 may cause compression and/or decompression of a spring. In embodiments, a spring may wind and/or unwind and be connected and/or to an electricity generator via a driveshaft. In embodiments, winding and/or unwinding of a spring may cause rotation of a drive shaft, which in turn causes an electricity generator to generate an analog and/or digital electrical signal representing current and/or voltage values.

In embodiments, a digital and/or analog electrical signals may have a value of 0.1 milliamps up to 3 amps and/or 0.1 millivolts up to +/−5 volts. In an embodiment, values of a digital and/or analog electrical signal may be small (e.g., milliamps and/or millivolts). Depending upon amount of wind in an environment where a tree may be located, values of a digital and/or analog electrical signals may be larger. In embodiments, it is not necessary for each branch to generate large values of current and/or voltage because a plurality of tree branch clasps, generator devices, and processing devices may be installed in each tree and a number of trees may have a plurality of tree branch clasps, generator devices and processing devices installed. This may allow a tree branch power generation system to generate more electricity and/or power.

In embodiments, a generation apparatus/generator devices 108 may comprise a rotation assembly 121 and an electrical generator 122. In embodiments, a cable 110 may be connected to a generation apparatus 108. In embodiments, a cable 110 may be connected to a bottom surface of a generation apparatus 108. In embodiments, a cable 110 may be connected to an electrical generator 122, and may be connected to a bottom surface of an electrical generator 122 of the generation apparatus 108. In an embodiment, a cable 110 may be connected and/or coupled to an end of an electrical generator 122 distal from an end of an electrical generator 122 connected to and/or coupled to a rotation assembly 121. In embodiments, a cable should not be installed, located and/or positioned by a rotation assembly 121, so as not to become entangled with rotation or movement of a rotation assembly 121 and/or a wire 106 connected to a rotation assembly 121. In embodiments, a cable 110 may be insulated to protect cable 110 from weather conditions in an environment where a tree is located. In embodiments, a cable 110 may be colored to blend into an environment having trees, e.g., brown, camouflage, or other similar colors.

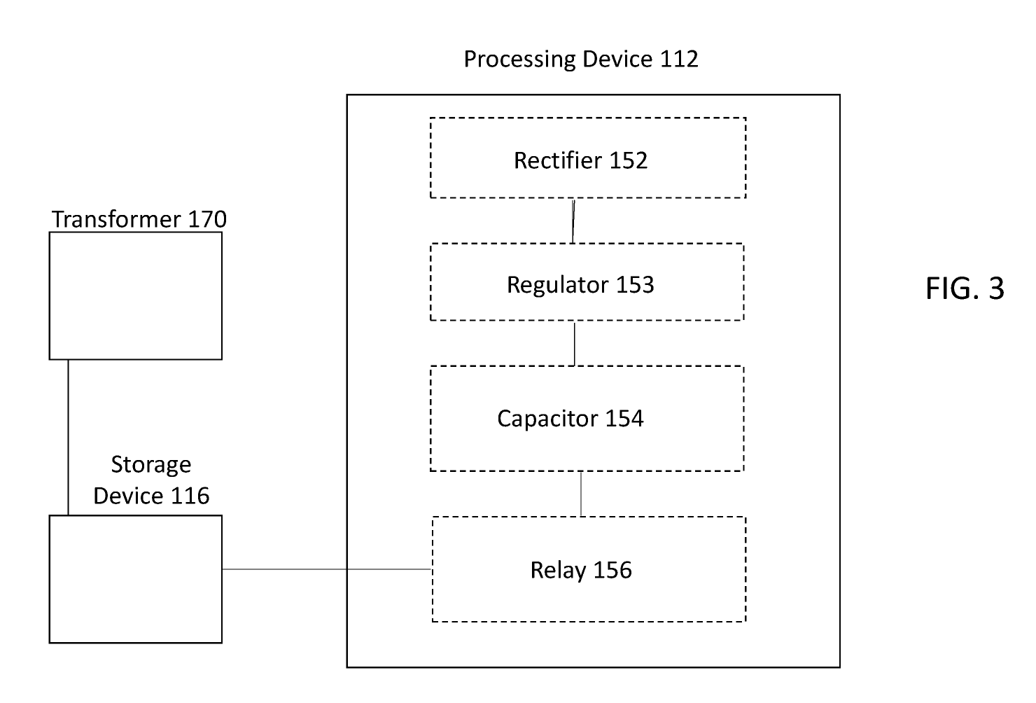

In embodiments, a cable 110 may be connected to a processing device 112. In embodiments, one or more cables 110 coupled to one or more generation devices 108 may be coupled on another end of cables 110 to a single processing device 112. In embodiments, a cable 110 may be coupled to a single processing device 112. FIG. 3 illustrates a processing device according to an embodiment. In embodiments, a processing device 112 may comprise a rectifier 152, a regulator 153, and/or a capacitor 154. In embodiments, a rectifier 152 may receive an analog and/or digital electrical signal and convert it to a constant voltage and/or current. In embodiments, a rectifier 152 may convert a positive and/or negative polarity communicated analog and/or digital electrical signal. In other words, a rectifier may handle both polarities of a communicated electrical signal representing current and/or voltage values. In embodiments, a generation apparatus/generator device, if rotated and/or moved in a clockwise direction, may generate one polarity value (e.g., positive or negative polarity) analog and/or digital electrical signal, and if rotated and/or moved in a counterclockwise direction, may generate an opposite polarity value (e.g., negative or positive polarity) analog and/or digital electrical signal.

In embodiments, a regulator 153 in a processing device 112 may protect against large values or amplitudes in analog and/or digital electrical signals communicated from a processing device 112. In embodiments, a regulator 153 may protect another component of a processing device 112 from overvoltage and/or overcurrent conditions in communicated analog and/or digital electrical signals. In an embodiment, a rectified electrical signal may create and generate a charge in a capacitor 154. A value of a charge in a capacitor 154 may be based, at least in part, on a voltage and/or current value of a received analog or digital electrical signal, which corresponds to an amplitude and/or value of how much movement may have been caused in a rotation apparatus 121.

In embodiments, one or more capacitors 154, may store charges associated with analog and/or digital electrical signals for one or more generation devices 108. In other words, a processing device 112 may comprise an array of capacitors 154. In embodiments, an array of capacitors may store charges associated with analog or digital electrical signals communicated by the generation device 108. In other words, there may be a one-to-one relationship, and/or many-to-one relationship between a generation device 108 and a processing device 112 (e.g., there may be 1, 5, or 10 generation devices 108 connected and/or coupled to a processing device 112).

In embodiments, a processing device 112 may further comprise a relay 156. In an embodiment, once a charge voltage and/or current value reaches a predetermined value, a relay 156 triggers a transfer of power and/or electricity (e.g., a voltage or current signal) from a processing device 112 to a storage device 116. In embodiments, a controller and/or a switching device may be coupled and/or connected to a relay 156 and, when activated or instructed, may cause a relay 156 to trigger a transfer of a voltage and/or current electrical signal from a processing device 112 to a storage device 116. In an embodiment, a computing device and/or a network device may also provide instructions to a processing device 112 (e.g., to cause a relay to trigger a transfer of a voltage and/or current signal from a processing device 112 to a storage device 116).

In embodiments, a processing device 112 may be coupled and/or connected to a power storage device 116. In embodiments, an additional cable 118 may connect and/or couple a processing device 112 to a power storage device 116. In embodiments, an additional cable 118 may be an insulated cable to protect an additional cable 118 from weather conditions in an environment where a tree is located. In embodiments, a power storage device 116 may comprise a rechargeable battery. In embodiments, power signals derived from a capacitor 154 in a processing device 112 and communicated to a power storage device 116 may charge a rechargeable battery in a power storage device 116. In embodiments, a power storage device 116 may comprise an array of capacitors to store voltage and/or current communicated from a processing device. In embodiments, a power storage device 116 may be coupled and/or connected to a transformer 170. A transformer 170 may convert stored voltage and/or current signals in a storage device to power, and power/electricity can be utilized by an electricity grid. In other words, a power storage device 116 may transfer power to an electricity grid, e.g., supply power to an electricity grid. In embodiments, a power storage device 116 may be coupled through an inverter and/or a transformer to transfer voltage and current electrical signals to an electricity grid. In embodiments, a processing device 112 may be coupled and/or connected to an electricity grid. In embodiments, a processing device 112 may be coupled and/or connected to an electricity grid through a transformer and/or an inverter. Although a rechargeable battery and an array of capacitors is described herein, power and/or electricity may be stored in a variety of manners, utilizing a variety of components and/or devices. In embodiments, a computing device and/or a network device may control operation of a storage device 116 when a storage device is communicating with a transformer and/or an electricity grid. In embodiments, a computing device and/or a network device may communicate over an Internet with a storage device 116.

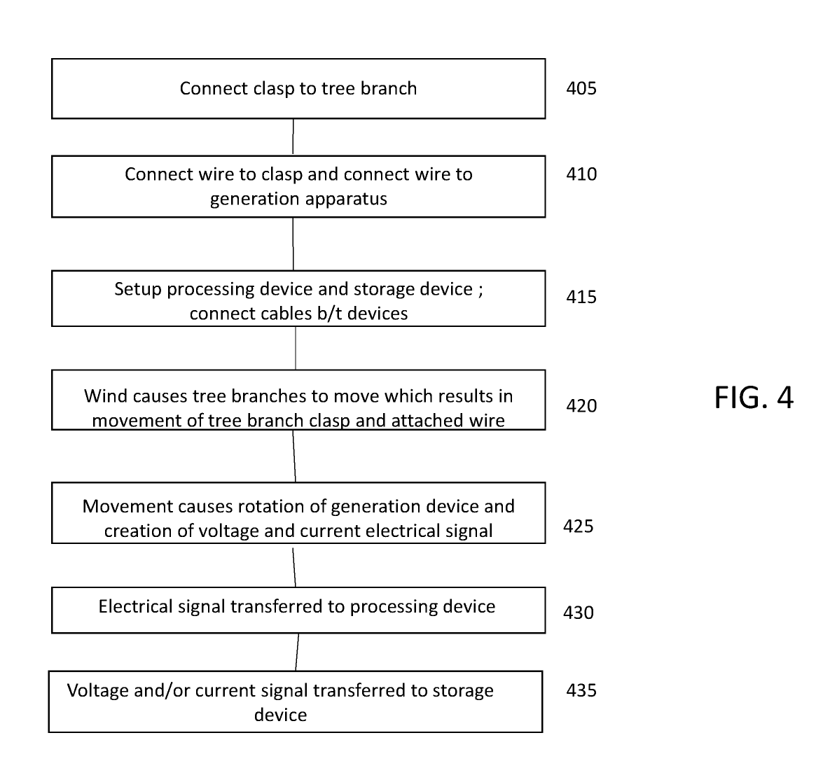

FIG. 4 is a flow diagrams for an embodiment of a process for use of the embodiments of FIGS. 1, 2 and 3. However, again, claimed subject matter is not limited to illustrative examples, such as FIGS. 1, 2, 3, and 4, for example. Of course, embodiments are meant to illustrative examples rather than be limiting with respect to claimed subject matter. Thus, it is intended that alternate arrangements of components in other implementations be included within claimed subject matter. Likewise, an embodiment of a method may include blocks in addition to those shown and described, fewer blocks, blocks occurring in a different order than may be identified, or combinations thereof. Likewise, for ease of implementation, an embodiment may be simplified to illustrate aspects and/or features in a manner that is intended to not obscure claimed subject matter through excessive specificity and/or unnecessary details. Embodiments in accordance with claimed subject matter may include all of, less than, or more than blocks 405 to 435. Also, the order of blocks 405-435 is merely as an example order.

FIG. 4 illustrates a flowchart of a tree branch power generation system according to an embodiment. In step 405, a tree branch clasp and/or harness is connected to a tree branch. In an embodiment, a plurality of tree branch clasps may be connected, placed around and/or placed on one or more tree branches of a tree. In embodiments, one or more tree branch clasps may be placed on one or more tree branches in one or more trees. In step 410, an end of a wire, e.g., a thin wire, may be connected to a tree branch clasp, in a variety of manners, and another end of a wire may be connected to a generation apparatus or generating device. In embodiments, for a tree, one or more wires may be connected between one or more tree branch clasps and one or more generation apparatus. In embodiments, one or more wires may be coupled and/or connected to one or more power generation apparatuses. In step 415, a user may setup a processing device by connecting cable(s) from a generation apparatus. In an embodiment, multiple cables from multiple generation apparatus may be connected to one processing device. In embodiments, a user may setup a storage device by connecting cable(s) from processing devices to a storage device. In embodiments, a processing device and/or a storage device may be placed on a surface in an area near or next to a tree.

In step 420, weather conditions (e.g., wind) may cause tree branches to move in a variety of directions, which results in movement of an attached and/or connected tree branch clasp and/also a wire connected and/or attached to a tree branch clasp. Depending on wind direction and/or velocity, some or all of tree branches may move resulting in movement in a number of attached tree branches and/or tree branch wires. In step 425, movement of a wire causes a rotation of generation apparatus and specifically a rotation assembly of a generation apparatus. In an embodiment, movement of a wire causes rotation assembly to move, which in turn causes a generator (or electrical generator) to create an analog and/or digital signal having a current and/or voltage value, which may also be referred to as a voltage and/or current electrical signal. In step 430, a voltage and/or current signal is transferred and/or communicated to a processing device, which processes a signal and charges a component of the processing device based on a value of the communicated voltage and/or current signal. In step 435, once a component has reached a predetermined value and/or charge, a signal is created and communicated to a storage device to charge a non-volatile (or volatile) storage component of a storage device, such as a rechargeable battery. In embodiments, power in a rechargeable battery may be transferred to a power grid.

A computing device may be a server, a computer, a laptop computer, a mobile computing device, and/or a tablet. A computing device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

Internal architecture of a computing device includes one or more processors (also referred to herein as CPUs), which interface with at least one computer bus. Also interfacing with computer bus are persistent storage medium/media, network interface, memory, e.g., random access memory (RAM), run-time transient memory, read only memory (ROM), etc., media disk drive interface, an interface for a drive that can read and/or write to media including removable media such as floppy, CD-ROM, DVD, etc., media, display interface as interface for a monitor or other display device, keyboard interface as interface for a keyboard, mouse, trackball and/or pointing device, and other interfaces not shown individually, such as parallel and serial port interfaces, a universal serial bus (USB) interface, and the like.

Memory, in a computing device, interfaces with computer bus so as to provide information stored in memory to processor during execution of software programs such as an operating system, application programs, device drivers, and software modules that comprise program code or logic, and/or computer-executable process steps, incorporating functionality described herein, e.g., one or more of process flows described herein. CPU first loads computer-executable process steps or logic from storage, e.g., memory, storage medium/media, removable media drive, and/or other storage device. CPU can then execute the stored process steps in order to execute the loaded computer-executable process steps. Stored data, e.g., data stored by a storage device, can be accessed by CPU during the execution of computer-executable process steps.

Persistent storage medium/media is a computer readable storage medium(s) that can be used to store software and data, e.g., an operating system and one or more application programs, in a computing device or storage subsystem of a processing device and/or storage device. Persistent storage medium/media also be used to store device drivers, such as one or more of a digital camera driver, monitor driver, printer driver, scanner driver, or other device drivers, web pages, content files, metadata, playlists and other files. Persistent storage medium/media can further include program modules/program logic in accordance with embodiments described herein and data files used to implement one or more embodiments of the present disclosure.

A computing device or a processor or controller may include or may execute a variety of operating systems, including a personal computer operating system, such as a Windows, iOS or Linux, or a mobile operating system, such as iOS, Android, or Windows Mobile, or the like. A computing device, or a processor or controller in a processing device, generating device, and/or storage device may include or may execute a variety of possible applications, such as a software applications enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A computing device or a processor or controller in a generating device, a processing device, and/or a storage device may also include or execute an application to communicate content, such as, for example, textual content, multimedia content, or the like. A computing device or a processor or controller may also include or execute an application to perform a variety of possible tasks, such as browsing, searching, playing various forms of content, including locally stored or streamed content. The foregoing is provided to illustrate that claimed subject matter is intended to include a wide range of possible features or capabilities. A computing device or a processor or controller in a generating device, a processing device, and/or a storage device may also include imaging software applications for capturing, processing, modifying and transmitting image files utilizing the optical device (e.g., camera, scanner, optical reader) within a mobile computing device.

Network link typically provides information communication using transmission media through one or more networks to other devices that use or process the information. For example, network link may provide a connection through a network (LAN, WAN, Internet, packet-based or circuit-switched network) to a server, which may be operated by a third party housing and/or hosting service. For example, the server may be the server described in detail above. The server hosts a process that provides services in response to information received over the network, for example, like application, database or storage services. It is contemplated that the components of system can be deployed in various configurations within other computer systems, e.g., host and server.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

1. A tree power generation system, comprising:
one or more tree branch clasps, the one or more tree branch clasps to attach to branches of a tree;
one or more power generators; and
one or more wires coupling the one or more tree branch clasps to the one or more power generators, wherein movement in the branches of the tree causes movement in the one or more wires and the power generator generates electrical energy.

2. The tree power generation system of claim 1, wherein two or more tree branch clasps may be attached to one tree branch.

3. The tree power generation system of claim 1, further comprising one or more storage devices and one or more cables, one of more power generators transferring the generated electrical energy to the one or more storage devices via the one or more cables.

4. The tree power generation system of claim 1, the one or more tree branch clasps being positioned around a substantial portion of a circumference of the one or more tree branches.

5. The tree power generation system of claim 1, wherein a power generator of the one or more power generators further comprises a rotation assembly and an electrical generator.

6. The tree power generation system of claim 5, wherein a wire of the one or more wires is coupled to the rotation assembly and the rotation assembly is coupled to the electrical generator, and wherein movement of the wire causes movement of the rotation assembly, which results in the electrical generator generating an electrical signal.

7. The tree power generation system of claim 6, the rotation assembly furthering comprising a hub and a shaft assembly, wherein the wire is attached to the hub, and the hub is attached to the shaft assembly.

8. The tree power generation system of claim 7, further comprises the shaft assembly coupled to a motor, wherein movement of the wire causes circular rotation of the hub, which causes rotation of the shaft assembly and the motor to generate power.

9. The tree power generation system of claim 6, wherein the rotation assembly is a coil/recoil spring.

10. The tree power generation system of claim 9, wherein the coil/recoil spring is attached to a drive shaft and the drive shaft to an electrical generator, and compression/decompression of the coil/recoil spring causes rotation of the drive shaft, which causes the electrical generator to generate an electrical signal.

11. The tree power generation system of claim 1, further comprising one or more cables and at least one processing device, the one or more power generators to couple to the at least one processing device via the one or more cables.

12. The tree power generation system of claim 11, the at least one processing device further to comprise a rectifier, a regulator and/or a capacitor, the rectifier to convert a received electrical signal to a voltage value and/or current value.

13. The tree power generation system of claim 12, the regulator to protect the at least one processing device from overvoltage and/or high current conditions.

14. The tree power generation system of claim 12, the capacitor to store a charge corresponding to the converted voltage value and/or the current value.

13. The tree power generation system of claim 11, the at least one processing device further to comprise one or more rectifiers and/or one or more capacitors, the rectifier to convert the received electrical signals to a DC voltage value and the one or more capacitors to store charges corresponding to the converted DC voltage value.

14. The tree power generation system of claim 13, the at least one processing device further to comprise a relay and a storage device, wherein the relay to trigger a transfer of the charge in the one or more capacitors to the storage device.

15. The tree power generation system of claim 14, the storage device to comprise a rechargeable battery.

16. The tree power generation system of claim 14, the storage device to comprise an array of capacitors.

17. The tree power generation of claim 14, further comprising a transformer, the transformer to convert stored voltage and/or current in the storage device to power to be transferred to an electricity grid.

18. A method comprising:
connecting a tree branch clasp to a tree branch;
coupling a power generation device to the tree branch clasp via a wire; and
connecting a power generation device to a processing device via a cable, wherein movement of the tree branch causing the power generation device to generate voltage and/or current, the generated voltage and/or current transferred to the processing device.

19. The method of claim 18, further comprising transferring the voltage and/or current to the storage device via another cable once the voltage and/or current value meets or exceeds a predetermined value.
